(19) United States
(12) Patent Application Publication
(10) Pub. No.: US 2008/0106500 A1
(43) Pub. Date: May 8, 2008

(54) Amolded direct voltage pixel drive for minaturization

(76) Inventor: Ihor Wacyk, Briarcliff, NY (US)

Correspondence Address: EPSTEIN DRANGEL BAZERMAN & JAMES, LLP, 60 EAST 42ND STREET, SUITE 820, NEW YORK, NY, 10165, US

(21) Appl. No.: 11/592,833

(22) Filed: Nov. 3, 2006

(51) Int. Cl. G09G 3/30

(52) U.S. Cl. 345/76

(57) ABSTRACT

The drive circuit for an OLED is designed for use with an external reference voltage source. The OLED is connected to the reference voltage source through a PMOS drive transistor. The circuit includes a data signal transmission gate responsive to a control signal for transmitting the data signal to the OLED. It also includes a storage capacitor and a second transistor. The capacitor is connected between the gate and the source of the drive transistor. The second transistor has an output circuit connected between the reference voltage source and the capacitor. The gate of the second transistor is operably connected to receive the control signal.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to pixel driver circuits for active matrix organic light emitting diode (AMOLED) displays and microdisplays and, more particularly, to such a circuit that permits further reduction of the size of the pixel while maintaining good pixel uniformity and performance.

2. Description of Prior Art Including Information Disclosed Under 37 CFR 1.97 and 1.98

There are many publications, for example those published in the SID Symposium Proceedings 2001 through 2004 that relate to overcoming the problem of threshold voltage variation for poly and amorphous silicon based direct view AMOLED displays. I am also aware of several patent application publications, including: Pub. No. 20030234754, Pub. No. 20040021653 and Pub. No. 20040032217 that are directed to the same issue. However, the implementation of which I am aware that is closest to the present invention is a design from IBM, described in an article entitled TFT AMOLED Pixel Circuits and Driving Methods, J. Sanford and F. Libsch, published in the Journal of the SID Symposium Proceedings of 2003, pp 10-13, that uses a modified voltage follower pixel driving circuit with compensation for threshold voltage variation.

The techniques published by OLED display designers mostly address direct view displays (displays having a diagonal greater than 2″ typically) using non crystalline silicon processes. They were primarily developed to address the high threshold voltage variability inherent to those processes. Because of the relative large display size (when compared to microdisplays) there is no need for very low current operation and therefore none of those displays make use of the subthreshold region.

The threshold voltage compensation techniques described in these publications are of two types:
voltage based compensation using a second storage capacitor to store the threshold voltage at each pixel; and
current based compensation using a technique similar to that first developed in the eMagin Corporation SVGA+ microdisplay as described in O. Prache, “Full-color SVGA+OLED-on-silicon microdisplay”, Journal of the SID, pp 133-138, 2002.

Pixel drivers can be configured as either current sources or voltage sources to control the amount of light generated by the OLED diode in an active matrix display. AMOLED microdisplays require very low amounts of current to generate light, especially when using analog gray scale rendition techniques. OLEDs have typically been driven in current mode due to the linear dependence of luminance on operating current. For low light level applications, a typical OLED microdisplay pixel current is about 200 pA.

Traditionally a long channel transistor is used to generate the output current. Realizing a compact circuit that can fit in a microdisplay application precludes the use of very long channel transistors. Operation in the sub-threshold mode has been used for the current range of OLED microdisplays to overcome this limitation. However, with further scaling of the silicon process and reduced pixel sizes, it becomes more problematic to implement a current driven design due to area constraints, matching errors, and increased leakage currents.

A significant benefit of the voltage drive mode is the ability to miniaturize the pixel cell while still providing good control for low light applications. Very long channel transistors are not required as the drive transistor can be operated as a voltage source with good pixel to pixel uniformity. Miniaturization is a key driver to reduce the cost of AMOLED microdisplays and provides a strong incentive to implement a voltage mode of operation for next generation products.

An NMOS switch used in source follower mode provides a basic implementation of a voltage source drive, as shown in FIG. 1. A major drawback of that approach is that it suffers from a large body effect in a typical low-cost N-well semiconductor process. The large body effect significantly reduces the output swing of the driver. However, for good visual performance the pixel voltage source needs to operate over as much of the supply range as possible and consist of as few transistors as possible to fit within the reduced pixel area.

### BRIEF SUMMARY OF THE INVENTION

In contrast to the NMOS source follower design illustrated in FIG. 1, the diode connected PMOS driver of the present invention operates to within one Vtp of the supply rail. Moreover, the present invention adds only one transistor to the basic NMOS source follower circuit, while still retaining an advantage of 20% fewer devices compared to the basic current driven cell. In addition, the voltage cell requires two fewer control lines for operation compared to the existing current cell design, further reducing complexity and size.

Rather than using a direct current control for generating gray levels, the present invention uses a voltage to drive the OLED device. The pixel drive transistor is now operated as a voltage source employing the voltage stored on the pixel capacitor as a reference level for the OLED device voltage.

Although the PMOS drive transistor operates in the sub-threshold region, its operating point is not dependent on its gate to source voltage. Instead, the transistor is connected as a diode with its forward drop determined by the DATA voltage. The diode forward drop is set by programming a voltage onto the capacitor connected between the gate and drain, thus forming dynamically controlled voltage source. In this mode, the operating voltage for the OLED device is nearly proportional to the programming voltage signal. Small variations in the threshold voltage between PMOS drivers within the array result in only relatively minor differences between OLED voltages applied to the pixels, resulting in a good pixel to pixel uniformity even with minimum size transistors.

The maximum output voltage of the diode with this design is limited to one threshold below the positive rail. Since the drive transistor is a PMOS device, it is not subject to the body effect in a standard N-well semiconductor process. Also, the PMOS devices in the pixel array can be isolated from digital and other noise that is generated in the substrate by containing them in a separate N-well that is tied to a quiet voltage source, further improving low current and low light level performance in the microdisplay.

Thus, it is a primary objective of the present invention to enable miniaturization of the next generation AMOLED microdisplays, consistent with minimum requirements for pixel uniformity and standard silicon processing. However, the concept underlying the invention is also applicable to larger format displays that use an active matrix architecture.

The benefit is a less expensive device with improved image quality that is required for large volume applications.

The above objectives are achieved through the use of a unique drive circuit for an OLED, as described below. The circuit is designed to receive a reference voltage from an external source. The OLED is operably connected to the reference voltage source through a PMOS drive transistor configured to function as a diode. The circuit includes data signal transmission gate means responsive to a control signal for transmitting the data signal to the OLED. Means are provided for controlling the forward bias of the drive transistor to be a function of the threshold voltage of the drive transistor.

The forward bias controlling means includes a storage capacitor and means for setting one side of the capacitor to the reference voltage, in response to the control signal. That side of the capacitor is operably connected to the gate of the drive transistor. The other side of the capacitor is operably connected to the source of the drive transistor.

The setting means includes a second transistor. The second transistor has an output circuit operably connected between the reference voltage source and the side of the capacitor that is to be set to the reference voltage. The gate of the second transistor is operably connected to receive the control signal. The second transistor functions to set one side of the capacitor to the reference voltage in response to the control signal.

The transmission gate means preferably takes the form of a CMOS transmission gate.

The forward bias of the drive transistor is preferably set to a value that is equal to the threshold of the drive transistor, plus the voltage across the storage capacitor.

In accordance with another aspect of the present invention, a drive circuit for an OLED is provided. The drive circuit is designed for use with an external reference voltage source. The OLED is operably connected to the reference voltage source through a PMOS drive transistor. The circuit includes data signal transmission gate means responsive to a control signal for transmitting the data signal to the OLED. It also includes a storage capacitor and a second transistor. The capacitor is operably connected between the gate and the source of the drive transistor. The second transistor has an output circuit operably connected between the reference voltage source and the capacitor. The gate of the second transistor is operably connected to receive the control signal.

### BRIEF DESCRIPTION OF THE SEVERAL VIEWS OF DRAWINGS

To those and to such other objects that may hereinafter appear, the present invention relates to an AMOLED direct voltage pixel drive circuit for miniaturization, as described in detail in the following specification, taken together with the annexed claims and illustrated in the accompanying drawings, wherein like numerals refer to like parts and in which:

FIG. 1 is a schematic diagram of a typical prior art NMOS source follower implementation of a pixel voltage driver;

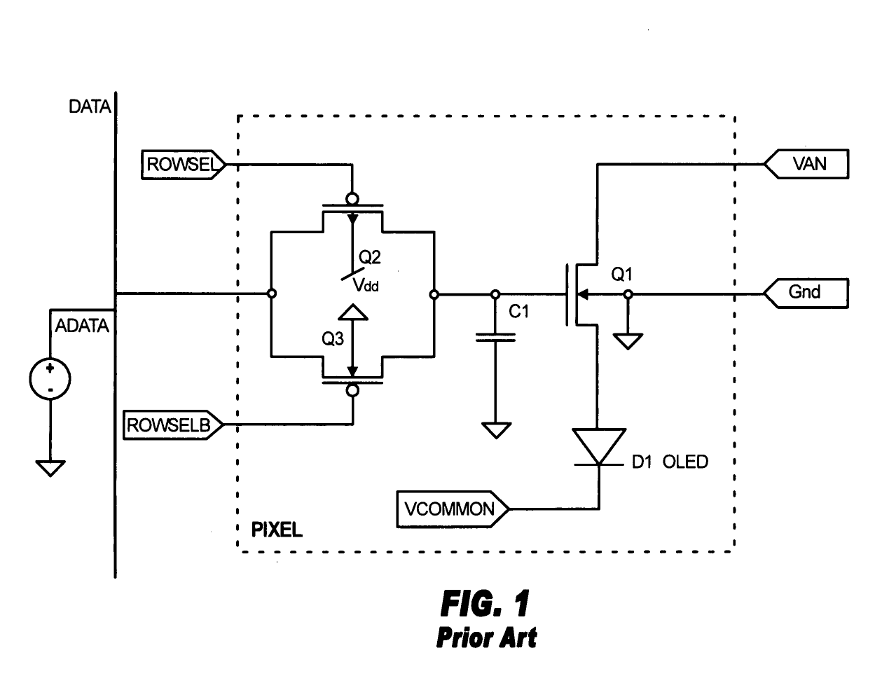

FIG. 2 is a schematic diagram of the drive circuit of the present invention; and

FIG. 3 is the pixel drive timing diagram for the circuit of FIG. 2.

### DETAILED DESCRIPTION OF THE INVENTION

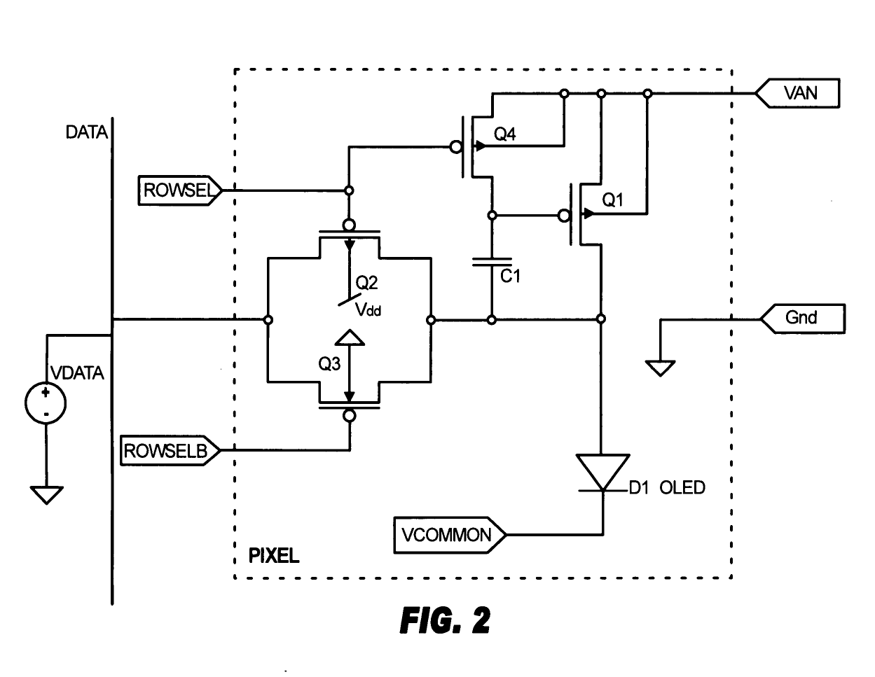

FIG. 2 shows a pixel driver that is based on a voltage source consisting of transistor Q1 and a storage capacitor C1. Transistor Q1 is configured as a MOS diode with the diode forward bias equal to the device threshold voltage plus the voltage across the capacitor C1. The current in the OLED is set by the voltage on the PMOS diode.

A CMOS transmission gate consisting of a transistor Q2 and a transistor Q3 acting as switches forms the data line access switch for the pixel. Both switches are closed by control signals ROWSEL and ROWSELB, respectively, during the programming phase in order to write data into the pixel. Both are opened at the end of the programming phase. In addition, the drain to substrate junction of transistor Q3 forms a clamp diode that protects the rest of the pixel circuitry from shorts across the OLED D1.

Transistor Q4 is used to preset one side of the storage capacitor to a fixed reference voltage during the pixel programming phase, eliminating pixel to pixel variability. During the programming phase, the transistor Q4 is rendered conductive by control signal ROWSEL, which is applied to its gate, so that the gate of drive transistor Q1 is tied to its source and transistor Q1 is turned off. At the end of the programming phase, transistor Q4 is turned off, along with the data line access switches in the transmission gate, by the control signal. As the voltage on OLED D1 falls, the gate to source voltage for drive transistor Q1 increases by the same amount via capacitor C1. Equilibrium is reached when the threshold for drive transistor Q1 increases by the same amount via capacitor C1. Once equilibrium is reached, any further attempt for the OLED voltage to drop is counterbalanced by drive transistor Q1 turning on harder and bringing the voltage back up.

The resulting voltage at OLED D1 after the programming phase will be the column data voltage VDATA minus one PMOS threshold drop. A compensation circuit can be used to add a voltage offset equal to one PMOS threshold to the input signal before the column data voltage VDATA is applied to the pixel. As a result, the final pixel voltage will be equal to the input signal with the consequence that the maximum voltage swing across the OLED is reduced by one threshold drop below the supply rail reference voltage VAN supplied by the reference voltage source.

Since drive transistor Q1 is acting as a diode in the sub-threshold MOS region, its IV characteristic is exponential and very steep. However, the operating point which is formed by the intersection of the PMOS diode curve with the OLED diode curve is relatively insensitive to the threshold voltage of the PMOS device.

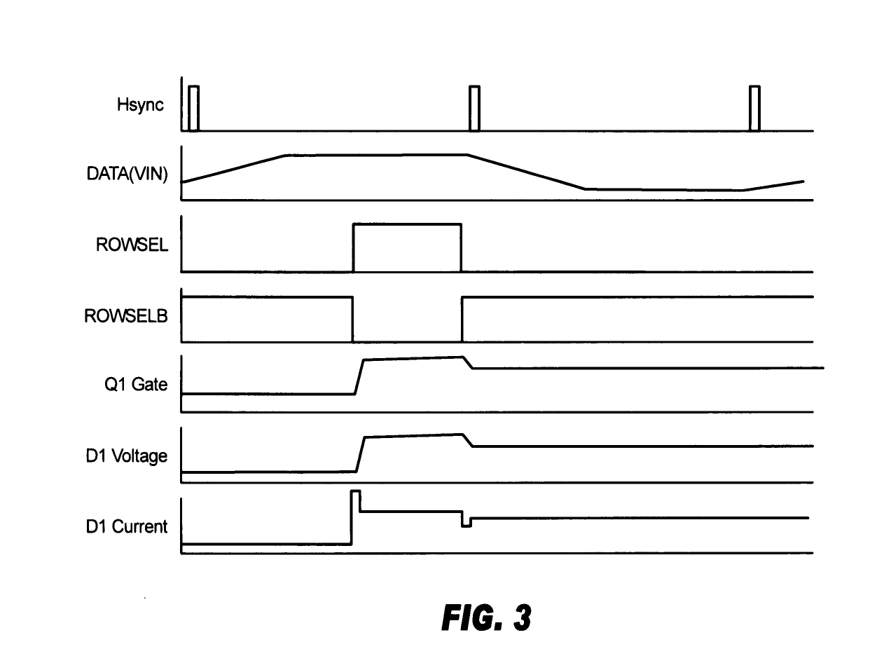

FIG. 3 shows the timing diagram detailing the sequence of operation for the pixel driver circuit of the present invention illustrated in FIG. 2.

The HSYNC signal shown in FIG. 3 is the line synchronization reference, provided here for reference. The diagram shows the programming and run sequence for one row of the active matrix display.

A. The Programming Phase:

Upon detection of a new Hsync period, the next row of data is applied to the column lines for loading into selected row of pixels. The DATA (VIN) signal shown is the data applied to one such column line. After a short time in which the data signal is allowed to settle, the row access switching transistors Q2 and Q3 are turned on with the respective ROWSEL and ROWSELB control signals. At the same time, the ROWSEL signal turns on transistor Q4 which immediately clamps the gate of transistor Q1 to the VAN reference voltage supply. The top side of capacitor C1 is also connected to the VAN reference voltage supply.

The CMOS transmission gate formed from transistors Q2 and Q3 connect the DATA(VIN) signal directly to the anode of OLED D1. The DATA signal is a voltage source so the voltage on OLED D1 rises quickly to the programmed value. During the transition, a current pulse occurs through the diode as its capacitance is charged. When the DATA(VIN) level is reached at OLED D1, its current stabilizes at the value corresponding to its voltage as given by its IV characteristic. During the programming phase, the current in diode D1 is entirely supplied by the DATA signal source. Since the gate of drive transistor Q1 is clamped to VAN it is completely shut off. Capacitor C1 is charged to a voltage equal to the VAN supply minus the DATA(VIN) signal during the program phase.

Depending on the previous voltage state of OLED D1, the diode current will either be increased or decreased during the program phase. In this example, it is shown as being programmed to a higher voltage level, resulting in an increase in diode current. In either case, the final state is reached rapidly as the diode is driven by a voltage source that is capable of rapidly charging or discharging the diode capacitance.

B. The Run Phase:

At the beginning of the next line period, transistors Q2, Q3 and Q4 are all turned off. The simultaneous turning off of transistors Q2 and Q4 across both sides of capacitor C1 results in a cancellation of charge injection in the capacitor from these devices. The remaining charge injection from transistor Q3 can be cancelled externally. In the run phase, the capacitor C1 is allowed to float as it is no longer actively clamped to VAN. In fact, it forms a fixed voltage source between the gate and drain of drive transistor Q1 with a value equal to the voltage it was charged to during the program phase.

Immediately after transistors Q2, Q3 and Q4 are turned off, the current flowing through OLED D1 is diverted into capacitor C1, forcing the gate of drive transistor Q1 to be discharged and its voltage to drop. The voltage on drive transistor Q1 will drop until its threshold is reached and it begins to source current. The voltage will stabilize at approximately this point since any attempt to further reduce the gate voltage is counteracted by the increased drive current of drive transistor Q1 which tends to raise the voltage at OLED D1 and consequently the gate via capacitor C1. As shown in FIG. 3, this results in a run value for the voltage on OLED D1 which is one PMOS threshold below the program value. An offset voltage equal to one PMOS threshold can be added to the DATA signal before it is applied to the column line to compensate for the drop in the pixel.

C. The Test Phase:

A capability to test each individual OLED device for opens and shorts is provided with the pixel topology shown in FIG. 2. This is possible since each individual diode is accessible through the data lines when the respective data access switches are closed. In previous pixel drive implementations there is always a drive transistor between the data line and the OLED diode which precludes direct testability.

Testing can be implemented as a special mode which essentially follows the timing shown the program phase. Transistors Q2, Q3 and Q4 are opened and a test voltage (or current) is applied to each data line. At the same time, a comparator with an appropriate sensor can be used to detect if the resulting data line current (or voltage) is within an acceptable range to qualify as a good pixel. The comparator data can be stored in a shift register and fed out through a serial port after each row is tested to check the entire array. Various test pattern can be used to test for adjacent row or column faults as well.

It will now be appreciated that the present invention relates to a pixel driver circuit for a microdisplay that uses direct voltage control mode permitting a reduction in the size of the pixel through the elimination of very long channel transistors while at the same time achieving good control for low light applications. The drive transistor is operated as a voltage source in order to provide good pixel to pixel uniformity.

While only a single embodiment of the present invention had been disclosed for purposes of illustration, it is obvious that many variations and modification could be made thereto. It is intended to cover all of those variations and modifications that fall within the scope of the present invention, as defined by the following claims:

I claim:

1. A drive circuit for an OLED for use with a reference voltage source, said OLED being operably connected to said reference voltage source through a PMOS drive transistor configured as a diode, said circuit comprising data signal transmission gate means responsive to a control signal for transmitting the data signal to said OLED and means for controlling the forward bias of said drive transistor as a function of the threshold voltage of said drive transistor.

2. The circuit of claim 1 wherein said forward bias controlling means comprises a storage capacitor and means for setting one side of said capacitor to the reference voltage in response to the control signal.

3. The circuit of claim 2 wherein said one side of said capacitor is operably connected to the gate of said drive transistor and the other side of the capacitor is operably connected to the source of said drive transistor.

4. The circuit of claim 2 wherein said setting means comprises a second transistor having an output circuit operably connected between the reference voltage source and said one side of said capacitor.

5. The circuit of claim 3 wherein said setting means comprises a second transistor having an output circuit operably connected between the reference voltage source and said one side of said capacitor.

6. The circuit of claim 4 wherein the gate of said second transistor is operably connected to receive the control signal.

7. The circuit of claim 5 wherein the gate of said second transistor is operably connected to receive the control signal.

8. The circuit of claim 1 wherein said transmission gate means comprises a CMOS transmission gate.

9. The circuit of claim 4 wherein said second transistor functions to set said one side of said capacitor to the reference voltage in response to the control signal.

10. The circuit of claim 5 wherein said second transistor functions to set said one side of said capacitor to the reference voltage in response to the control signal.

11. The circuit of claim 2 wherein said function of said threshold voltage equals the threshold of said drive transistor plus the voltage across said capacitor.

12. The circuit of claim 3 wherein said function of said threshold voltage equals the threshold of said drive transistor plus the voltage across said capacitor.

13. A drive circuit for an OLED for use with a reference voltage source, said OLED being operably connected to the reference voltage source through a PMOS drive transistor, the circuit comprising data signal transmission gate means responsive to a control signal for transmitting the data signal to said OLED, a capacitor, said capacitor being operably connected between the gate and the source of said drive transistor, and a second transistor having an output circuit operably connected between the reference voltage source and said capacitor, the gate of said second transistor being operably connected to receive the control signal.
